(19) United States
(12) Patent Application Publication
(10) Pub. No.: US 2009/0270010 A1
(43) Pub. Date: Oct. 29, 2009

(54) Pacifier holder

(76) Inventors: Jessie Christene Scott, Friendswood, TX (US); Chelsea Ann Scott, Brownwood, TX (US)

Correspondence Address: John William Sparks, Suite 116, 1350 Nasa Parkway, Houston, TX, 77058, US

(21) Appl. No.: 12/150,537

(22) Filed: Apr. 29, 2008

(51) Int. Cl. A63H 3/00; A63H 3/02; A61J 17/00

(52) U.S. Cl. 446/73; 446/72; 446/369; 606/234

(57) ABSTRACT

A pacifier holder is disclosed having a stuffed toy affixed to a pacifier.

### FIELD

The embodiments of this invention relate to pacifiers for infants.

### BACKGROUND

Parents have great love for their children. Babies enter this world completely helpless, mute, and full of great potential. Babies have many needs and parents usually spend much time trying to discern what their baby needs from the baby's cries and other actions.

Babies cry when they are hungry, need a diaper change, are too hot, are uncomfortable, have a pacifier fall out of their mouth, and sometimes they cry for no discernable reason. Babies require almost incessant care during the first several months of life. Caring for a baby can leave parents sleep deprived, cranky, and amazed.

Parents work hard to take care of their children and anticipate their needs. Many of the products that parents buy are to make the baby happy, comfort the baby, and keep the baby from crying. Crying not only affects the development of the baby, it also affects the disposition of the parents. A crying baby can be an unwelcome interruption during those two to four hours of quality sleep that a parent may be getting.

Pacifiers are commonly used to comfort a baby. When the pacifier falls out of the mouth, the baby starts crying until the pacifier is replaced in the baby's mouth. Pacifiers are small and easy to lose in blankets, crib, carrier, clothing, and vehicles. With the pacifier affixed to the stuffed toy, older infants may be able to re-find the pacifier because it is attached to their stuffed toy.

Parents need a pacifier holder that makes the pacifier difficult to lose and makes the pacifier easier to find. Parents want a pacifier holder that serves as a stuffed toy. Babies love stuffed toys.

The present invention satisfies these needs.

### SUMMARY

The present invention is directed to a pacifier holder that incorporates a stuffed toy with a pacifier, wherein the pacifier is affixed to the stuffed toy. The pacifier can be affixed to the stuffed toy by a fastening means. The pacifier can be revocably affixed to the stuffed toy.

The pacifier is usually affixed to the muzzle of the stuffed toy. The oral end of the pacifier protrudes from the stuffed toy and the handle end is usually affixed to the stuffed toy. The pacifier is affixed to the stuffed toy by fasteners. The pacifier can be revocably affixed to the stuffed toy. A revocably affixed pacifier is easier to clean. The pacifier can be reversible to allow storing the oral end of the pacifier within the muzzle of the stuffed toy when the pacifier is not in use.

The stuffed toy is usually a stuffed toy animal, a doll character, a teddy bear, or is a plush toy. The pacifier can be affixed to the muzzle, hand, or neck of the stuffed toy. The pacifier can be affixed to the neck of the stuffed toy by using a lanyard. The stuffed toy can have a muzzle or hand made of an easy to wash surface of polymer, ceramic, or glass. A stuffed toy made of a washable, soft or fuzzy material is preferred.

The stuffed toy can have pockets for storing other things. Audio equipment, baby wipes, diapers, ointment, and other baby supplies could be stored in the pockets of the stuffed toy. Some of the pockets can be cavities for storing large items.

These and other features, aspects, and advantages of the present invention will become better understood with regard to the following description, appended claims, and accompanying drawings.

### BRIEF DESCRIPTION OF THE DRAWINGS

FIG. 1 depicts an embodiment of the pacifier holder.

### DESCRIPTION

In accordance with some embodiments, described herein, a pacifier holder is disclosed. The present invention is directed to a pacifier affixed to a stuffed toy by a fastening means. The stuffed toy can have the appearance of any animal, person, character, doll, or cartoon. The pacifier will usually be attached to the mouth, muzzle, head, or neck of the stuffed toy. The mouth or muzzle of the stuffed toy is a preferred affixation site on the stuffed toy.

A “pacifier” is a binky, a piece, a comforter, a dummy, a teether, an elastic gum ring, or a soother. The term “pacifier” expressly includes any nipple-shaped protrusion having a mouth shield, a base, or a handle end. A pacifier has an oral end, usually a mouth shield, and a handle end. The oral end of the pacifier is the end of the pacifier that is usually inserted into the baby's mouth. The term “handle end” is the end of the pacifier that is opposite the oral end of the pacifier. A mouth shield is a safety shield that prevents a baby from swallowing the pacifier by making the mouth shield too big to fit in the baby's mouth. Mouth shields are sometimes an optional feature of pacifiers. Pacifiers are usually made of rubber, plastic, silicone, or elastic material.

A “stuffed toy” is a stuffed animal, a plush toy, a teddy bear, a soft toy, a plushie, a cuddly toy, an animated character, a doll, an angel, a stuffed animated creature or a doll designed to look like a person or religious character. A “stuffed toy” is a fabric sewn into the shape of an animal, a person, or a creature and stuffed with straw, beans, cotton, fabric, packing peanuts, or other material so as to resemble an animal, person, or creature. The term “pocket” expressly includes pouches, cavities, orifices, and channels.

A “muzzle” is a snout or projecting jaws and nose of an animal or creature. The term “muzzle” expressly includes the mouth and face of the stuffed toy. A “lanyard” is a rope, a line, a cord, a cable, or a strap. A lanyard can be made of leather, polymer, composite, or plant fibers. “Audio equipment” is any means of producing sound. The term “audio equipment” expressly includes radios, mp3 players, compact disc players, and cassette players.

The term “affixed” expressly includes fastening with a fastener or a fastening means. A “fastener” or a “fastening means” can be any fastener or fastening system, including a lanyard tying components together, a clip, a pin, snaps, a latching mechanism, stitching, a clamp, an orifice with a clamp, hook and eye tape, a slot with a clip, opposing magnets within the components, a zipper, or a button and buttonhole.

The pacifier holder is made by creating or acquiring a stuffed toy, creating or acquiring a pacifier, affixing a fastening means to either the stuffed toy or the pacifier, and affixing the stuffed toy and the pacifier together, wherein the oral end of the pacifier protrudes from the stuffed toy. A pacifier can be permanently affixed or revocably affixed to the stuffed toy. A revocably affixed pacifier and stuffed toy is a preferred embodiment of the invention.

The oral end of the pacifier protrudes from the stuffed toy to give an infant access to the oral end of the pacifier when using the pacifier holder. The pacifier holder can be used by affixing the pacifier to the stuffed toy and placing the pacifier of the pacifier holder into the mouth of the baby. An infant, lying on their back, would suckle or teethe the oral end of the pacifier while the stuffed toy is disposed on the infant's chest. The pacifier holder should be washed frequently when being used.

The pacifier holder can be a bottle holder by making the stuffed toy with a pouch or pocket for receiving a baby bottle. The baby bottle can be affixed to the pacifier holder. The paws of the stuffed toy can be fastened so as to wrap around a baby bottle to secure the baby bottle to the stuffed toy.

The stuffed toy can be made with one or more torso cavities. Audio equipment can be disposed within the cavities of the stuffed toy. A blanket can be disposed within the cavities of the stuffed toy. A blanket can be affixed to the pacifier holder.

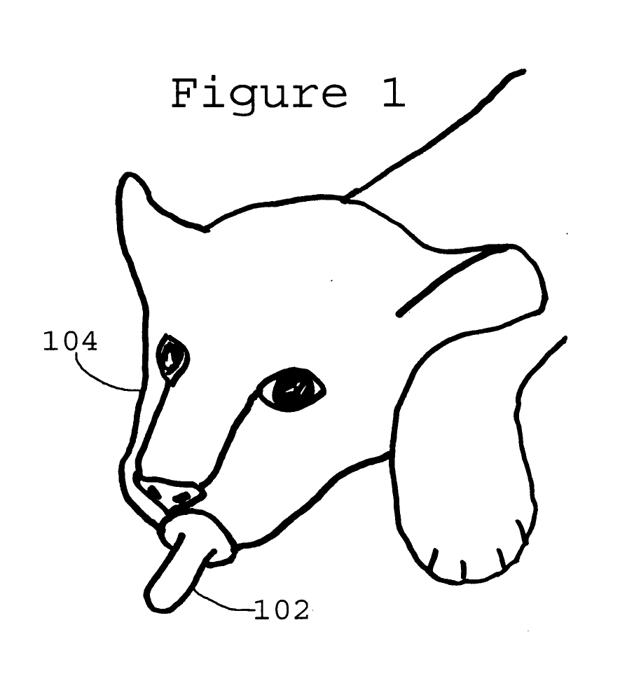

In FIG. 1, a version of the pacifier holder is depicted. The pacifier holder has a pacifier 102 and a stuffed toy 104. The pacifier 102 has an oral end and a handle end. The stuffed toy 104 is a baby big cat stuffed toy showing a muzzle, a head, and a paw. The oral end of the pacifier 102 protrudes from the muzzle of the stuffed toy 104 and the handle end of the pacifier 102 is affixed to the muzzle of the stuffed toy 104. The stuffed toy 104 has a mouth opening in which the pacifier 102 is deposited. The mouth of the stuffed toy 104 is an orifice having a clamp affixed to the outward surface of the mouth. The clamp is an oblong ring which deforms and opens when pressure is applied to the oblong ring in a particular way. The clamp of the stuffed toy's mouth holds the pacifier 102 in place. The clamp is a revocable fastening means.

A preferred embodiment of the invention would be lightweight, soft, and washable. The pacifier holder is preferably made to be washable. The stuffed toy and pacifier can be washable. A version of the pacifier holder having a pacifier permanently affixed to the stuffed toy should be made to allow the washing of the entire pacifier holder.

Where the pacifier is revocably affixed to the stuffed toy, the stuffed toy and the pacifier can be washed separately or washed together. A stuffed toy with a washable face or hands would be a preferred feature. A washable face would be a face made from a polymer, ceramic, or glass. A polymer would be a preferred material for making the face or hands washable.

An embodiment of the pacifier holder would have an animal or animated character as the stuffed toy. A preferred embodiment of the pacifier holder would have audio equipment affixed to the stuffed toy or disposed within the stuffed toy. The audio equipment can be deposited within a cavity within the body of the stuffed toy. The audio equipment could emit music or heart beat sounds. Music and heart sounds are good for quieting a baby.

A preferred embodiment of the pacifier holder would have pockets, one or more body cavities, and a pouch. Pockets, cavities, and pouches could be used for storing baby wipes, towels, fresh diapers, wash cloths, and other baby care products. A baby bottle could be affixed to or stored within the stuffed toy of the pacifier holder. The stuffed toy could serve as a bottle holder. The stuffed toy can be formed with features that stabilize the body of the stuffed toy when the stuffed toy is disposed on the baby's chest.

A preferred embodiment of the pacifier holder has the pacifier affixed or revocably affixed to the stuffed toy. The pacifier could be affixed to the muzzle or snout of the stuffed toy. The handle end or base end of the pacifier could be affixed to the muzzle of the stuffed toy. The pacifier may be affixed to the stuffed toy by a lanyard. A preferred embodiment of the pacifier holder would have a revocable affixment of the pacifier to the stuffed toy and a lanyard affixing the pacifier to the stuffed toy.

A pacifier holder can be made with a reversible pacifier. The stuffed toy could have a muzzle that allows the oral end of the pacifier to be stored in the mouth or muzzle of the stuffed toy when the pacifier is not being used by a baby. When the pacifier is wanted by the infant, the pacifier can be replaced into a position where the oral end of the pacifier protrudes from the muzzle of the stuffed toy. A reversible pacifier version of the pacifier holder would be a good feature for traveling and storage.

A blanket could be affixed to the pacifier holder. The blanket could be affixed to the legs, torso, or feet of the stuffed toy. The edge of the blanket could be positioned near the head of the stuffed toy. The body, legs, and ears of the stuffed toy could have extra material whereby the extra material forms a blanket for the infant.

The pacifier can have the appearance of a banana. The stuffed toy can have the appearance of a primate and the stuffed toy can be holding the banana in the hand of the primate. When this embodiment is used with an infant, the primate will appear to be feeding a banana to the infant. The stuffed toy can be made to resemble a lifeguard with a pacifier designed to look like a whistle hung around the neck of the lifeguard so that the baby looks like they have the lifeguard's whistle in their mouth.

The pacifier can be affixed to the mouth or muzzle of the stuffed toy. When this embodiment is used with an infant, the stuffed toy will have the appearance of kissing the infant. The stuffed toy could be made to resemble a parent or relative so the pacifier holder when used with an infant will appear to be a parent or relative kissing the infant.

Another version would be to have the stuffed toy resemble a religious character so that when the pacifier holder is used, the religious character appears to be kissing the infant. Possible religious characters are Jesus, the Pope, Dalai Lama, Buddha, a preacher, a jolly fat friar, an angel, an apostle, or a saint.

While the invention has been described with respect to a limited number of embodiments, those skilled in the art will appreciate numerous modifications and variations therefrom. It is intended that the appended claims cover all such modifications and variations as fall within the true spirit and scope of the invention.

What is claimed is:

1. A pacifier holder, the article comprising:
a pacifier having a handle end and an oral end, and
a stuffed toy, wherein the pacifier is affixed to the stuffed toy.

2. The pacifier holder of claim 1, wherein the stuffed toy is an animated creature.

3. The pacifier holder of claim 1, wherein the stuffed toy resembles an animal.

4. The pacifier holder of claim 3, wherein the stuffed toy has a muzzle.

5. The pacifier holder of claim 4, wherein the handle end of the pacifier is affixed to the muzzle of the stuffed toy.

6. The pacifier holder of claim 1, wherein the pacifier is revocably affixed to the stuffed toy.

7. The pacifier holder of claim 4, wherein the pacifier is revocably affixed to the muzzle of the stuffed toy.

8. The pacifier holder of claim 1, wherein the pacifier is affixed to the stuffed toy by a lanyard.

9. The pacifier holder of claim 4, wherein the oral end of the pacifier protrudes from the muzzle of the stuffed toy.

10. The pacifier holder of claim 1, wherein the stuffed toy has pockets.

11. The pacifier holder of claim 1, wherein the stuffed toy is a bottle holder.

12. The pacifier holder of claim 1, further comprising:
a blanket, wherein the blanket is affixed to the stuffed toy.

13. The pacifier holder of claim 12, wherein the stuffed toy is laying on the blanket.

14. The pacifier holder of claim 1, further comprising:
audio equipment, wherein the audio equipment is affixed to the stuffed toy.

15. The pacifier holder of claim 14, wherein the audio equipment is revocably affixed to the stuffed toy.

16. The pacifier holder of claim 14, wherein the audio equipment emits heart sounds.

17. The pacifier holder of claim 14, wherein the audio equipment emits music.

18. The pacifier holder of claim 1, further comprising:
audio equipment, wherein the audio equipment is disposed within the stuffed toy.
